(19) United States
(12) Patent Application Publication
(10) Pub. No.: US 2016/0282059 A1
(43) Pub. Date: Sep. 29, 2016

(54) LAYERED HEAT TRANSFER DEVICE AND METHOD FOR PRODUCING A LAYERED HEAT TRANSFER DEVICE

(71) Applicant: MAHLE INTERNATIONAL GMBH, Stuttgart (DE)

(72) Inventor: Thomas SCHIEHLEN, Altheim (DE)

(73) Assignee: MAHLE INTERNATIONAL GMBH, Stuttgart (DE)

(21) Appl. No.: 14/777,843

(22) PCT Filed: Mar. 17, 2014
(86) PCT No.: PCT/EP2014/055322

§ 371 Date: Sep. 17, 2015

(30) Foreign Application Priority Data
Mar. 18, 2013 (DE) 10 2013 204 744.4
Mar. 18, 2013 (DE) 20 2013 101 450.8

(51) Int. Cl. F28F 3/08; H01M 10/0525; H01M 10/6556; H01M 10/625; H01M 10/6554; B23P 15/26; H01M 10/613

(52) U.S. Cl. CPC F28F 3/086; B23P 15/26; H01M 10/0525; H01M 10/613; H01M 10/625; H01M 10/6554; H01M 10/6556; F28F 2275/025; H01M 2220/20

(57) ABSTRACT

The invention relates to a method for producing a layered heat transfer device or a subelement of a layered heat transfer device, wherein a connecting layer is arranged between at least one channel plate and at least one cover plate and/or between at least two channel plates, wherein a joint, in particular an adhesive joint, is formed between the at least one channel plate and the at least one cover plate or between at least two channel plates. The invention likewise relates to a layered heat transfer device which has cover plates and a channel plate stack arranged between said cover plates. The cover plates and the channel plates of the channel plate stack are connected to one another by means of a connecting layer in the form of an adhesive layer.

### TECHNICAL FIELD

The invention relates to a method for producing a layered heat transfer device, to a part-element of a layered heat transfer device according to the preamble of claim 4, and to a layered heat transfer device according to the preamble of claim 5.

### PRIOR ART

Layered heat transfer devices are known and are employed, for example, for cooling small-format energy storage devices, for example lithium-ion battery cells, or power electronics components. Employment of a fluid cooling medium in the layered heat transfer devices here enables more efficient cooling of power electronics components and battery cells, on account of which a more compact construction and installation in a reduced installation space, for example in a motor vehicle, is enabled.

The layered heat transfer device typically comprises duct plates having cooling ducts, through which the fluid coolant flows, and cover plates having media connectors for the coolant, by way of which a closed construction of the layered heat transfer device is enabled.

DE 20 2012 102 349 U1 disclosed a battery cooler which is used in temperature control of battery cells in a vehicle battery by means of a heat-transferring fluid. The battery cooler has a structural plate having one flow duct with two or more passages for the fluid, and a receiving plate having a connector piece. The flow duct is shaped by way of a lateral duct limitation in the structural plate.

WO 2010/136524 A1 filed by the inventor refers to a layered heat transfer unit for high temperatures, having a housing and a layered block disposed therein, wherein the layered block is constructed from layered panels having flow ducts and cover plates. The layered panels and the cover plates are interconnected by soldering or welding.

During welding, high temperatures are employed at least in a localized manner, and there is the risk of the components being distorted and of expensive rework being required. Soldering as a joining method has the disadvantage that only materials capable of soldering may be employed in the layered panels and the cover panels. Moreover, the use of a soldering furnace is required for the soldering process, requiring the parts to be brought into the soldering furnace and to be mounted there by means of complex soldering frames. The method using soldering is altogether time consuming and is expensive on account of the high energy investment required for maintaining a temperature of approx. 600° in the soldering furnace for many hours.

It is the object of the invention to develop a layered heat transfer device which enables a simple and materially economical connection between various duct plates and cover plates. Moreover, it is the object of the present invention to provide an improved method for producing a layered heat transfer device which is simple and cost effective.

This is achieved by a method for producing a layered heat transfer device or a part-element of the layered heat transfer device, wherein a connection layer is disposed between at least one duct plate and at least one cover plate, and/or between at least two duct plates, and a join connection, in particular an adhesive connection, is implemented between the at least one duct plate and the at least one cover plate, or between two duct plates.

This may be achieved in that the connection layer is formed and the join connection, in particular the adhesive connection, is thus configured.

The join connection, in particular the adhesive connection, is preferably achieved by applying pressure. The pressure is preferably applied to the plate which is in each case on the outside, either to the cover plates or to the outer duct plates.

The pressure is preferably between 0.05 and 2 N/mm², particularly preferably between 0.1 and 0.7 N/mm². A thermal input may be additionally provided. The joining process may be supported by way of a moderate elevated temperature, and the join connection, in particular the adhesive connection, may be more rapidly implemented in this way. The employed temperature is preferably between 120 and 180° C. and is applied over a comparatively short period of time which is preferably less than 10 minutes, typically about 3 minutes.

The thickness of the connection layer is minor and is preferably a few μm. The thickness of the connection layer is particularly preferably between about 10 μm and 100 μm. However, if and when required, the thickness may also be a few hundred μm, for example when the duct plates and/or the cover plates to be adhesively bonded are made from selected materials having various coefficients or longitudinal expansion. The connection layer is preferably coffered as a film material between the cover plate and the duct plate, or between individual duct plates, respectively, and thereafter compressed under pressure and/or directly laminated onto the duct or cover plates.

It is advantageous for the pressure to be adapted to the number of plates and the thicknesses thereof, so as to achieve optimal compression and implement a durable and stable adhesive connection. On account of the method according to the invention, fluid-tight layered heat transfer device having cover plates and interdisposed duct plates with cooling ducts offering altogether good heat dissipation and thus good cooling properties is created.

The advantage of the adhesive method according to the invention lies in that duct plates and/or cover plates from various materials are connectable. In particular, duct plates and/or cover plates from materials having various coefficients of heat expansion and various corrosive potentials may be interconnected.

The method steps are significantly simpler and more cost effective than the steps of the conventional soldering method, since the use of a soldering furnace may be dispensed with. Moreover, the joining process is significantly more flexible, on account of the use of the comparatively thin connection layer in the form of the adhesive film. Moreover, also materials which are not accessible to the soldering process may be employed as duct plates and cover plates, for example non-metallic materials. Copper which, on account of its good thermal conductivity properties, is known as a material for the duct plates and/or cover plates, may also be employed as a material for the duct plates and/or cover plates in the method according to the invention. In the previously used soldering furnaces copper could not be employed, since this would lead to contamination of the soldering furnace.

The thin layer thickness of the adhesive film employed as a connection layer is likewise an advantage of the method according to the invention, since high thermal conductivity between duct plates and between the duct plate and the cover plate is ensured. Moreover, on account of the minor material thickness of the connection layer in the form of a film, economical use of the adhesive material as a jointing material may be ensured, on account of which the material costs may be significantly reduced.

Also in comparison to other adhesive methods having liquid adhesive materials and multi-component adhesives, the method according to the invention is altogether simpler and more cost effective, since complex machines for applying a liquid adhesive and curing times in the furnace may be dispensed with. For example, the use of silicone-based adhesives would require a curing time of 1 to 2 hours in the furnace.

In one design embodiment of the method, laminated plates, in particular laminated duct plates and/or cover plates, are used with an adhesive film. This enables simple coffering of the individual duct plates and cover plates prior to applying pressure.

The object is also achieved by a part-element of a layered heat transfer device and of a layered heat transfer device for cooling battery cells or power electronics components, said part-element having at least one cover plate and at least one duct plate, or at least two duct plates, wherein at least one connection layer is disposed between the at least one duct plate and the at least one cover plate, or the at least two duct plates, said connection layer being a jointing layer which is configured as an adhesive layer. On account thereof, the construction of the part-element of a layered heat transfer device is simplified.

The duct plates and the cover plates may advantageously be made from various materials. The connection layer is produced in a materially economical manner from a thin adhesive film, on account of which high thermal conductivity of the jointing layer is implemented. The connection layer may contribute toward structural strength. A part-element advantageously is a duct-plate stack which is producible in separate manner by way of the method according to the invention.

The layered heat transfer device according to the invention has a first cover plate and a second cover plate and a duct-plate stack disposed between the cover plates, wherein a connection layer is disposed between the duct plates of the duct-plate stack and between the first and second cover plate and the respectively adjacent duct plates, said connection layer being configured as an adhesive layer. Here, the contour or the connection layer preferably corresponds to the contour of the duct plate, the contours being in particular almost congruent.

The thickness of the connection layer is very minor and is 5 and 1000 μm; the thickness of the connection layer is preferably between 10 and 100 μm. Preferably, the duct plate and/or the cover plate are configured as a panel, preferably a metal panel, which is laminated to the connection layer. This enables particularly simple processing and production of the layered heat transfer device.

In one preferred embodiment, the duct plates and the connection layer have clearances or embossings. The clearances are preferably in each case located at the end wall. Moreover, a clearance may likewise be provided in the direction of longitudinal extent. On account thereof, a flow of the coolant from an upper duct plate into a duct plate lying there below is enabled. The duct plates preferably have cooling ducts. A coolant, preferably a coolant fluid, may flow through the cooling ducts and implement heat transfer and thus dissipation of the heat loss of the components to be cooled. Cooling of a component which is thermally linked to the layered heat transfer device may be performed in that the coolant stream entering the layered heat transfer device is divided preferably among a plurality of duct plates. Part of the coolant may flow through the flow ducts of the upper duct plate, another part of the coolant stream may pass through the clearance in the duct plate and the connection layer and thus makes its way into the duct plates which are geodetically disposed there below. In this way, a layered heat transfer device having multiple passages is implemented and effective utilization of the coolant is ensured. The clearances may be machined into the duct plate by means of known production steps such as punching, milling, eroding, laser-cutting. Embossing a duct plate is also conceivable, the duct plate being capable of additionally assuming the function of the cover plate, such that a duct field which has been created will be insular or web-like.

The advantages und technical features which are listed in the description of the method are likewise applicable to the layered heat transfer device and vice versa.

Further advantageous design embodiments are described by the following description of the figures.

### BRIEF DESCRIPTION OF THE FIGURES OF THE DRAWING

In the following, the description will be explained in more detail by way of at least one exemplary embodiment by means of the figures of the drawing. In the drawing:

FIG. 1 shows a layered heat transfer device in an exploded view;

FIG. 2 shows a layered heat transfer device in section view;

FIG. 3 shows a further cross-sectional illustration of a layered heat transfer device;

FIG. 4 shows an illustration, of the method according to the invention for producing a layered heat transfer device.

### PREFERRED EMBODIMENT OF THE INVENTION

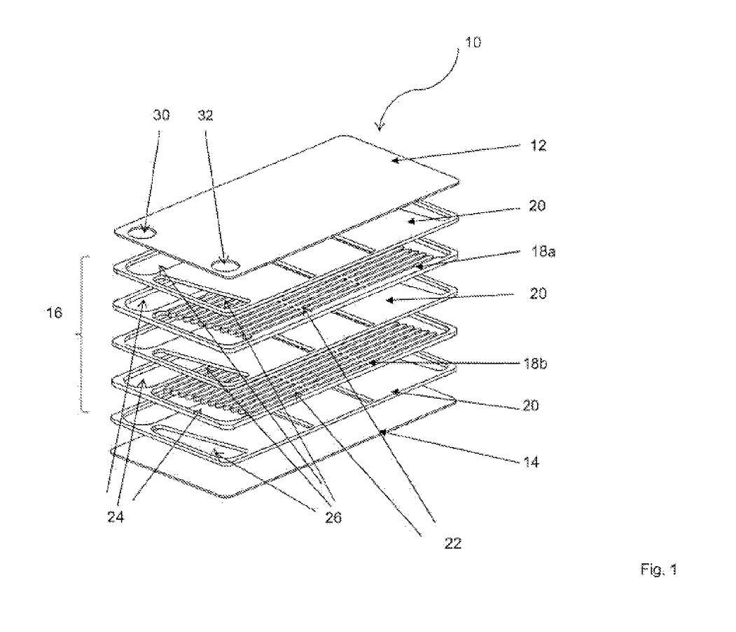

FIG. 1 shows a first exemplary embodiment of a layered heat transfer device 10 according to the invention in an exploded illustration in an isometric view. The layered heat transfer device 10 has a first upper cover plate 12 and a second lower cover plate 14. A stack 16 of duct plates 18a, 18b and connection layers 20, which is also referred to as the duct-plate stack 16, is disposed between the upper cover plate 12 and the lower cover plate 14. The duct plate 18a, 18b is in each case configured as a duct plate 18a, 18b, or a cooling panel 18, 18a, 18b, and has ducts 22 which function as cooling ducts 22 and in the assembled state of the layered heat transfer device 10 are adapted for receiving a coolant.

The coolant is preferably a fluid, for example a mixture of water and Glysantin, or a refrigerant, for example R134a or R1234yf. The duct plates 18a and 18b furthermore have clearances 24 through which the coolant (not illustrated) may make its way from the upper duct plate 18a into the duct plate 18b which is geodetically disposed there below.

The connection layer 20 is in each case disposed between the duct plates 18a and 18b. The connection layer 20 preferably has the same geometric dimensions as the duct plate 18, 18a, 18b, such that the complete face of the duct plate 18, 18a, 18b may be covered by the connection layer 20. The connection layer 20 has clearances 26 which correspond to the clearances 24 of the duct plate 18a, 18b in the geometric arrangement and have the same geometric design embodiment, such that in the fitted state of the layered heat transfer device 10 the clearances 24 and 26 are disposed on top of one another and the coolant may flow without obstruction from the upper duct plate 18a to the lower duct plate 18b.

Furthermore, connection layers 20 are likewise disposed between the upper cover plate 12 and the duct plate 18a, and the lower cover plate 14 and the duct plate 18b.

The cover plate 12 furthermore has clearances 30 and 32 to which the connectors (not illustrated) may be flanged. The layered heat transfer device 10 may be connected to a coolant circuit (not illustrated) by means of the connectors. For example, during operation the coolant may flow through the clearance 30 into the layered heat transfer device 10, flow along the coolant ducts 22, flow through the clearances 24 and 26 through the duct-plate stack 16, and exit the layered heat transfer device 10 by way of the other clearance 32 of the cover plate 12.

The cover plates 12 and 14 and the duct plates 18a, 18b are preferably made from a metal, for example from an alloyed steel. However, they may also be produced from copper or a copper alloy, or from a material containing titanium or aluminum, for example TiAl6V4 alloy. It may also be provided that the duct plates 18, 18a, 18b are made from a plastics material. The cover plates 12 and 14 may be made from the same material as the cooling panels 18a and 18b, but may also be produced from another material. When selecting the material it has to be ensured that good heat transfer exists between the cover plate 12 or 14, which is in contact with the component (battery or electronics component) to be cooled. The thickness of the cover plates 12, 14 and the cooling panels 18a, 18b is preferably between a few 100 μm and a few 100 mm.

The connection layer 20 is configured as an adhesive layer, preferably as a film from an adhesive material, and has a minor thickness of very few μm, for example a few 10 μm to 100 μm. The thickness of the connection layer 20 may also be a few 100 μm, if a comparatively larger layer thickness is required on account of various coefficients of longitudinal expansion of the material of the cover plates 12 and 14, and of the duct plates 18a, 18b. The material of the connection layer 20 may be any arbitrary adhesive by way of which a jointing layer which is configured as an adhesive connection between the duct plates 18, 18a, 18b among themselves and/or between the duct plate 18, 18a, 18b and the cover plate 12, 14 may be implemented.

For example, the connection layer 20 may be a film containing an acrylic ester, such as a high-performance film VHB 9469 by 3M, for example. Both organic adhesive films as well as inorganic adhesive films may be provided. However, other films may also be employed.

For example, the connection layer 20 may be composed of an organic or inorganic material having one or a plurality of components, which may cure automatically or by inputting energy, such as heat, radiation, or atmospheric humidity. These are preferably epoxy resins, silicone compounds, polyurethane, cyanacrylates, methyl methacrylates, anaerobically curing adhesives, non-saturated polyesters, phenol-formaldehyde adhesive, silicones, silane crosslinking polymer adhesives, polyimide or polysulfide adhesives, pressure-sensitive or hot-melt adhesives, contact or dispersion adhesives, water-based adhesives, or plastisols.

In one embodiment, the connection layer 20 may be connected to the duct plate 18a, 19b and/or the cover plate 12, 14 by laminating the duct plate 18 and/or the cover plate 12, 14 the adhesive film layer or the adhesive film. Here, metal coils are laminated with the connection layer 20, and the cover panels 12, 14 and the cooling panels 18 are then made from the metal coils by way of methods such as punching, eroding, laser-cutting, embossing, for example.

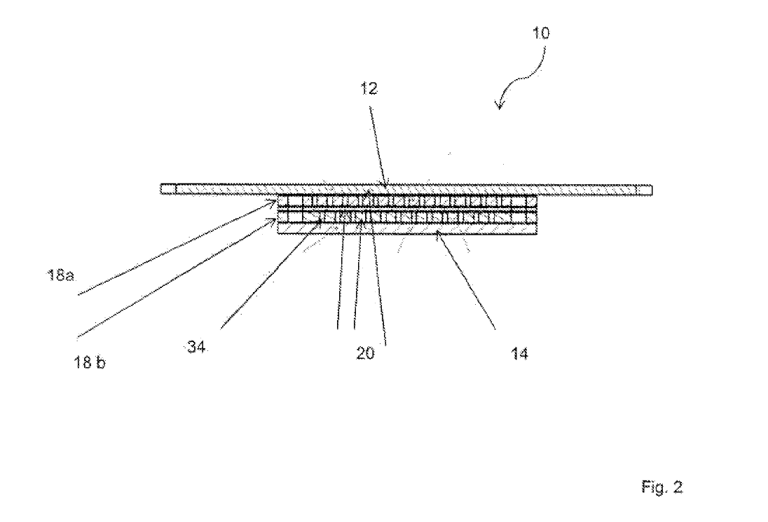

In FIG. 2 a layered heat transfer device 10 is shown in the fitted state as a cross-sectional illustration. The duct plates 18a and 18b are disposed between the cover plate 12 and the cover plate 14. The connection layer 20 is in each case disposed between the cover plate 12 and the duct plate 18a, between the duct plate 18a and the duct plate 18b, and between the duct plate 18b and the cover plate 14. In the fitted state of the layered heat transfer device 10, the connection layer 20 will have experienced a slight deformation which has arisen on account of the pressure applied in the method. On account of the pressure which is in the magnitude of a few hundredths N/mm², preferably 0.1 to 0.7 N/mm², having been applied, a fluid-tight connection between the individual plates 12, 14, 18a and 18b has been implemented. It can be seen that webs 34 are in each case disposed between the coolant ducts 22, which separate the individual ducts 22 from one another. In this embodiment of the layered heat transfer device 10 the webs 34 of adjacent duct plates 18a and 18b are offset by half a pitch.

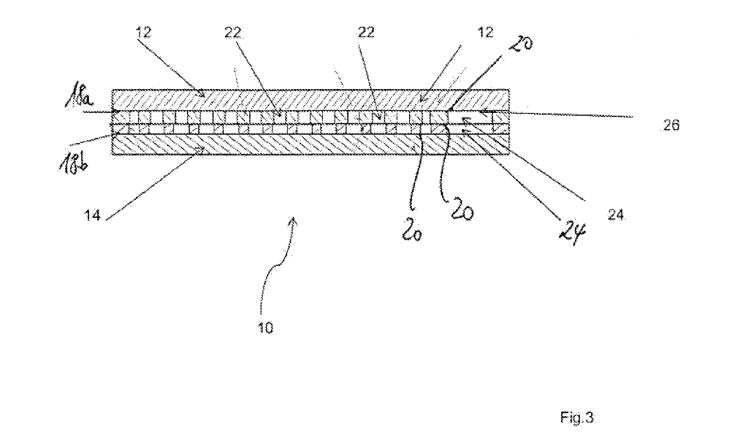

FIG. 3, in a cross-sectional illustration which is in a plane rotated by 90°, shows the layered heat transfer device 10 having the upper cover plate 12, the lower cover plate 14, and two duct plates 18a and 18b. In this illustration the section through the ducts 22 is identifiable. The clearance 26 on the direction of longitudinal extent of the layered heat transfer device 10 is likewise identifiable.

The layered heat transfer device 10 in FIGS. 1 to 3 is shown in an exemplary manner having two duct plates 18a and 18b. However, further duct plates 18c, 18d, etc., may be disposed between the cover plates 12 and 14, wherein a connection layer 20 which in the fitted state implements a gas-tight and fluid-tight connection between adjacent duct plates 18 is in each case disposed between one duct plate 18 and the adjacent duct plate 18, such that the coolant may only flow in the cooling ducts 22 an through the clearances 24 and 26.

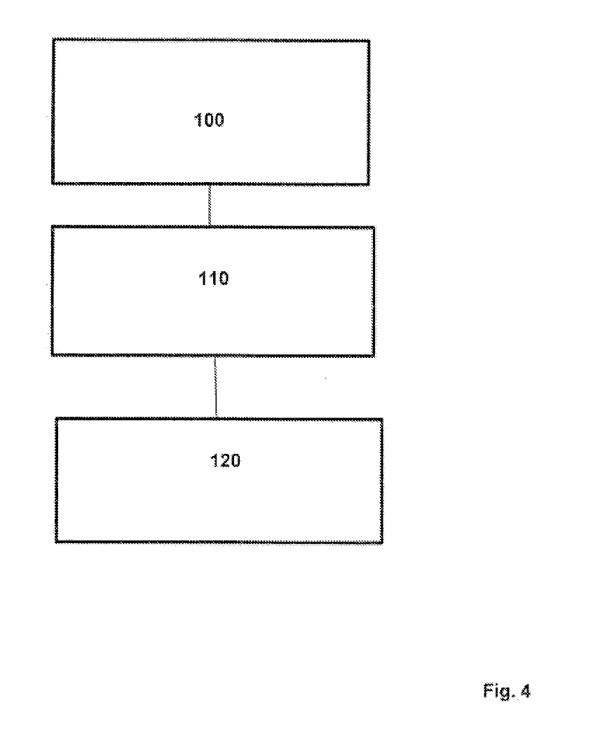

FIG. 4 shows the method according to the invention for producing a layered heat transfer device 10, or part-elements of the layered heat transfer device 10, for example for producing a duct-plate stack 16 and/or a part-element from in each case one cover plate 12 or 14 and a duct plate having interdisposed connection layers 20. The method comprises the steps:
method step 100: providing cover plates 12, 14; duct plates 18, for example duct plates 18a and 18b; connection layers 20, by way of a corresponding blank, or providing duct plates 18, 18a, 18b and connection layers 20, by way of a corresponding blank;
method step 110: disposing on top of one another, in particular stacking and coffering, cover plates 12, 14, duct plates 18, 18a, 18b, and connection layers 20, in a succession which corresponds to a construction of the layered heat transfer device 10 or of the part-element of the layered heat transfer device 10;
method step 120: applying pressure, preferably between 0.1 and 0.7 N/mm², preferably in a perpendicular manner to the surface of the topmost plate, in particular to the cover plates 12 and 14, wherein pressure may be applied either unilaterally to one of the cover plates or while the opposite cover plate 12, 14 is disposed on a firm base, or bilaterally, for example by clamping the stack from cover plates 12, 14, connection layers 20, and duct plates 18, 18a, 18b, between two plates which apply pressure. The plates applying pressure here preferably have the geometric dimensions of the cover plates 12, 14, so as to ensure uniform application of pressure. Introduction of heat, for example in a moderate temperature range of between 100° C. and 300° C., preferably between 120° and 100° C. may be provided in addition to the application of pressure during the time period of the application of pressure which is<10 min.

The duct plates 18 and the cover plates 12, 14 are preferably made from panels by punching, eroding, laser-cutting, or milling. The connection layer 20 which is configured as a thin adhesive film may be likewise produced by punching or cutting. The connection layer 20 and the duct plates 18 here have congruent clearances 26, preferably in each case at an end wall of the duct plate 18 and/or of the connection layer 20 and a direction of longitudinal extent.

In one design embodiment of the method metal coils which are laminated to the connection layer, in particular to the adhesive film, are employed, from which metal coils the duct plates 18, 18a, 18b, and the cover plates 12, 14, are produced, for example in a punching process. However, laminating of duct plates 18, 18a, 18b, and of cover plates 12, 14, may also be performed after a production process involving the contours of said plates.

### LIST OF REFERENCE SIGNS

10 Layered heat transfer device
12 First, upper cover plate
14 Second, lower cover plate
16 Stack of duct plates 18, duct-plate stack
18 Duct plate
18a Duct plate
18b Duct plate
20 Connection layer
22 Coolant duct
24 Clearance in the duct plate 18, 18a, 18b
26 Clearance in the connection layer 20
30 Clearance in the upper cover plate 12
32 Clearance in the upper cover plate 14
100 Method step 1
110 Method step 2
120 Method step 3

1. A method for producing a layered heat transfer device or a part-element of a layered heat transfer device, wherein a connection layer is disposed between at least one duct plate and at least one cover plate, and/or between at least two duct plates, wherein a join connection, in particular an adhesive connection, is configured between the at least one duct plate and the at least one cover plate, or between at least two duct plates.

2. The method as claimed in claim 1, wherein pressure is applied for producing the join connection, in particular the adhesive connection.

3. The method as claimed in claim 1, wherein a thermal input is provided.

4. A part-element of a layered heat transfer device for cooling battery cells or power electronics components, having at least one cover plate and at least one duct plate or at least two duct plates, wherein a connection layer is disposed between the at least one duct plate and the at least one cover plate, or the at least two duct plates, said connection layer being a jointing layer which is configured as an adhesive layer.

5. A layered heat transfer device for cooling battery cells or power electronics components, having a first cover plate and a second cover plate and a duct-plate stack which is disposed between the cover plates, wherein a connection layer is disposed between the duct plates of the duct-plate stack, and between the cover plate and the respectively adjacent duct plate, and/or between duct plates of the duct-plate stack, said connection layer being configured as an adhesive layer.

6. The layered heat transfer device as claimed in claim 5, wherein the contours of the connection layer of the duct plates are congruent.

7. The layered heat transfer device as claimed in claim 5, wherein the thickness of the connection layer is between 5 and 1000 μm, preferably between 10 and 100 μm.

8. The layered heat transfer device as claimed in claim 5, wherein the duct plate and/or the cover plate are configured as a panel, preferably a metal panel, which is laminated to the connection layer.

9. The layered heat transfer device as claimed in claim 5, wherein the duct plate and/or the connection layer have/has clearances.

10. The layered heat transfer device as claimed in claim 5, wherein the duct plate has cooling ducts.
